(19) United States
(12) Patent Application Publication
(10) Pub. No.: US 2004/0218462 A1
(43) Pub. Date: Nov. 4, 2004

(54) Concrete delivery system

(76) Inventor: Anthony Leon Stephens, Ormeau (CA)

Correspondence Address: YOUNG & THOMPSON, 745 SOUTH 23RD STREET 2ND FLOOR, ARLINGTON, VA, 22202

(21) Appl. No.: 10/478,667

(22) PCT Filed: May 23, 2002
(86) PCT No.: PCT/AU02/00651

(30) Foreign Application Priority Data
May 23, 2001 (AU) PR 5214

(51) Int. Cl. B28C 7/04

(52) U.S. Cl. 366/17; 366/34; 366/35

(57) ABSTRACT

Concrete is mixed and delivered on-site with slump continuously monitored on a real-time basis. A vehicle 10 having a compartment 11 holding blended aggregate and sand and a compartment 12 holding cement powder. An auger 13 carries the aggregate and sand to a mixer 14 coupled to the rear of the vehicle 10. As the aggregate and sand passes below the compartment 12 cement powder is dispensed by a paddle wheel dispenser 15 where the last stages of the auger 13 pre-coats the aggregate and sand with cement powder before delivering it into the mixer 14 where water is added. A slump indicator on a display shows departure of slump from a preset value so that customer may see that slump is being monitored and maintained on a dynamic basis. Merchant facilities are provided so that the concrete may be paid for in advance. The slump may be monitored on a tipping or non-tipping vehicle.

### TECHNICAL FIELD OF THE INVENTION

THIS INVENTION relates to delivery of concrete using a mobile dry to wet concrete system whereby the separate ingredients of concrete may be transported to a construction site dry and mixed together on-site in a manner that enables purchaser of concrete to verify concrete quality on a continuous delivery pre-paid basis.

### BACKGROUND TO THE INVENTION

Concrete has traditionally been batched at a central batching plant and then sent to the site as a wet mix in a conventional agitator bowl type mixer. While the initial batch is usually to standard specifications, the mixing during transit, the chemical reaction, the temperature degrades the concrete so that the slump is inherently difficult to control. It is also not uncommon for the mix to be tampered with, for example a mix that has thickened in transit may be made workable by adding extra water to the agitator bowl which further degrades the mix because it interrupts the reaction. The conventional batch system is not amenable to delivery of partial quantities and therefore there is much waste, where pay disputes arise, the supplier either delivers the concrete without first securing payment or may choose to withhold delivery, since this is not really a viable alternative the supplier may effectively be held to ransom by the purchaser, which means the supplier really has no choice but to deliver in the hope of being paid in the future. Continuous delivery systems eliminate some of these problems.

The applicant's U.S. Pat. No. 4,810,097 describes a mobile dispensing apparatus suitable for dispensing concrete on-site using ingredients carried dry to the site. The apparatus utilises a tip truck to feed monitoring augers with sand and aggregate respectively which in turn feed into a mixer along with cement powder. Water is then fed into the mixer. The apparatus is able to dispense concrete continuously consequently there is no “batching” function. Water, aggregate, sand and cement powder are mixed together and the continuous delivery may be stopped and started without loss. While this apparatus functions well there is a need for a suitable user interface that enables a purchaser to confidently purchase concrete knowing that the concrete is of a predetermined quality at the time of delivery.

### OUTLINE OF THE INVENTION

In one aspect the there is provided a mobile dry to wet concrete system for continuous mixing and delivery of concrete from dry ingredients on-site, the system comprising a vehicle having compartments holding separate the dry ingredients for concrete, a mixer downstream of the compartments for receiving the ingredients and mixing them together, characterised in that, the system has a customer interface including a slump monitor. The slump monitor preferably comprises visual indicator means activated automatically in the event slump of concrete being dispensed falls outside predetermined limits. The visual indicator means is typically a normally off indicator which comes on when the predetermined limits are exceeded. Typically, the normally off indicator includes separate high and low indicators, one of which is activated when the slump moves outside a predetermined slump window.

In another aspect there is provided a vehicle having compartments holding separate the dry ingredients for concrete, a mixer downstream of the compartments for receiving the ingredients and mixing them together, characterised in that, the vehicle is of the non-tipping type and the relative quantities of ingredients are controlled to remain constant during a mixing cycle, the dry ingredients delivered to the mixer being controlled continuously by means of metering and conveying means automatically maintaining the relative relationship between the amounts of dry ingredients throughout a mixing cycle for practical consistency of the mix throughout the cycle. The vehicle preferably includes a slump monitor. Preferbly the vehicle's metering and conveying means are linked mechanically by a longitudinally extending common drive shaft. Preferbly the vehicle's mixer is fixed relative to the vehicle having a discharge point into an inlet adapted to discharge into a concrete pump. In another case the vehicle's the mixer is a fixed mixer located at least in part within the periphery of the vehicle. Preferably the vehicle has at least three compartments holding dry ingredients, one compartment holding aggregate, one compartment holding fines and one compartment holding cement powder, each compartment having a conveyor, the conveyors of the aggregate and fines being dispersed to combine the aggregates and fines together prior to the cement powder being added.

The main function of the slump monitor is to monitor the concrete/water ratio of concrete being poured, and indicate when the mix is high (to much water), low (too little water) or correct slump. An operator is able to adjust water flow to a predetermined setting and thereby pour concrete of desired slump where the customer may view the slump monitor and if one of the indicators comes on see that the quality of the concrete at that moment is outside acceptable limits.

The slump is monitored using a flow sensor in the water line, a moisture sensor in the sand, a cement sensor, an adjustable water valve and a computer means.

Typical operation of the slump monitor is as follows:

1. The sand moisture sensor detects the % moisture in the sand and converted to litres at a rate of 1%=7.6 litres/m³;

2. The moisture “x %” is given in litres/m³ in 1 is deducted from the “slump factor” defined as 228 for 80 slump. For commercial purposes the slump factor to slump may be considered linear for the most common “batch designs”, this being the expression used for the aggregate, sand and cement in standard mixes. For example, 40 slump would have a slump factor of 114, half 228. This give “A”litres/m³ as the water rate for the required slump for 80 slump 228−(“x”×7.6)

3. The water flow valve is then checked against the “A” flow rate set on the computer which measures the flow sensor output and switches on the indicator lights until the flow comes within the computers set limits and the lights remain off. This is all set prior to any concrete being mixed so that the water content is dynamically displayed while the cumulative total of concrete is displayed for pricing purposes.

Typically a ratio metric method is used by reason of mechanically controlling dry ingredients in set ratio according to standard batch design requirements, the slump monitor simply monitors the amount of water/m³ of concrete by reason of the known mechanical dry ingredient delivery. Any deviation from the set ratio is displayed by the high/low indicators. Counting pulses from the water flow sensor and the cement powder sensor monitors the ratio. A typical water sensor would produce 50 pulses/litre, a typical cement sensor would produce 350 pulses/m³ of cement. Thus for 80 slump @ 10% sand moisture, “A”==152 litres/m³ of cement. This equates to 7600 water pulses per 350 cement pulses, a ratio of 21.7:1, the water wanted×0.143=required ratio (80 slump). Eg 152 litres of water×0.143=21.7 where 0.143 is the pulse ratio 50/350

The relative quantities of ingredients are controlled to remain constant during a mixing cycle, the dry ingredients delivered to the mixer being controlled continuously by means of metering and conveying means automatically maintaining the relative relationship between the amounts of dry ingredients throughout a mixing cycle for practical consistency of the mix throughout the cycle.

Preferably, water is also carried on the vehicle with the dry ingredients. The slump is preferably controlled by controlling the amount of water added to the mix in accordance with predetermined and adjustable settings.

The ingredients for making concrete commonly involve cement powder, aggregate, fines and water. The aggregate, fines and cement powder are usually formed into a dry mix before the water is added. The aggregate is often stone, gravel, blue metal or any other material that may be used to form a solid mass once the mix has cured and may also embrace recyclable material including shredded rubber, woodchip and crushed glass etc.

Fines are used to form the matrix about the aggregate. Typical fines used are sand but may embrace any fine material suitable for the purpose including fine recycled glass and various mixtures of fines.

The aggregate and fines may be held separately in the vehicle or may be pre-blended and held together in a single compartment. Thus the vehicle may have a compartment for sand and a separate compartment for gravel or a single compartment holding pre-mixed sand and gravel.

The vehicle typically controls the ingredients delivered to the mixer by metering devices linked together so that any variation from a constant delivery rate of one ingredient is accompanied by an automatic adjustment of the delivery rate of the other ingredient so that the relative relationship between the ingredients remains, for practical purposes of concrete quality, effectively constant.

The metering devices used for the aggregate and fines or the aggregate-fines blend typically comprise augers to both metre and convey, the compartments having inclined side walls causing the auger to be fed at capacity at all times so that a predictable flow is available until the compartment is empty. The metering device for the cement powder is typically a gravity fed paddle wheel delivering a constant rate of cement powder as the paddle wheel rotates. The water is typically delivered at a rate determined by the rotation of the paddle wheel so that the correct amount of water is delivered relative to the cement powder which in turn is delivered in proper relative quantity with the sand and gravel.

Preferably, the metering devices for the dry ingredients are all linked mechanically by a common drive shaft. Mechanical gearing is provided so that a range of standard batch designs may be replicated with separate gearing for each and the design changed by moving a chain drive to an appropriate gear. The cement powder is fully aerated yielding a predictable density of 1100 kg/m³. The water is typically delivered using a 100% positive drive pump at 40 psi and using a valve to control the rate. The sand and aggregate are typically set to British Standard Batch Design, for example the aggregate may comprise about 610 kg of 9 mm stone plus about 560 kg 18 mm stone per cubic metre, about 800 kg of blended fine and course sand to about 310 kg of cement powder giving a total of between 2350-2450 kg/m³.

The mixer may be attached to the vehicle. In this embodiment the mixer has a proximal end coupled to the vehicle and a distal end defining a discharge point, the mixer being coupled to the vehicle so that the discharge point may be moved relative to the vehicle. Alternatively, the mixer may be fixed relative to the vehicle having a discharge point into an inlet to a concrete pump, the concrete pump being of known type and being coupled to the vehicle adjacent the discharge point.

### BRIEF DESCRIPTION OF THE DRAWINGS

In order that the present invention may be more readily understood and be put into practical effect reference will now be made to the accompanying drawings which illustrate preferred embodiments and wherein:—

FIG. 1 is a block diagram of a concrete delivery system according to the present invention;

FIG. 2 is a schematic side view of a vehicle for a concrete delivery system according to the present invention;

FIG. 3 is a transverse section through a vehicle similar to the vehicle of FIG. 2;

FIG. 4 is a side view illustrating another embodiment;

FIG. 5 is a transverse section through the vehicle FIG. 4;

FIG. 6 is a plan view illustrating a typical arrangement for metering and conveying;

FIG. 7 is a further embodiment;

FIG. 8 is an embodiment particularly suited to pumped concrete;

FIG. 9 is a cut-away view illustrating a further arrangement for metering and conveying;

FIG. 10 is a cut-away view of a cement powder tank illustrating the operation of areating mats to areate the cement powder;

FIG. 11 is a drawing illustrating a typical water flow line suitable for a concrete delivery system according to the present invention;

FIG. 12 is a schematic drawing illustrating an arrangement for metering and conveying in a system employing a tipping vehicle;

FIG. 13 is a perspective view of an arrangement for metering and conveying illustrating multiple gears;

FIG. 14 is a perspective view of an arrangement for metering employing a gear box to enable flow rate of cement powder to be changed; and

FIG. 15 is a perspective drawing illustrating a display for a concrete delivery system according to FIG. 1;

### METHOD OF PERFORMANCE

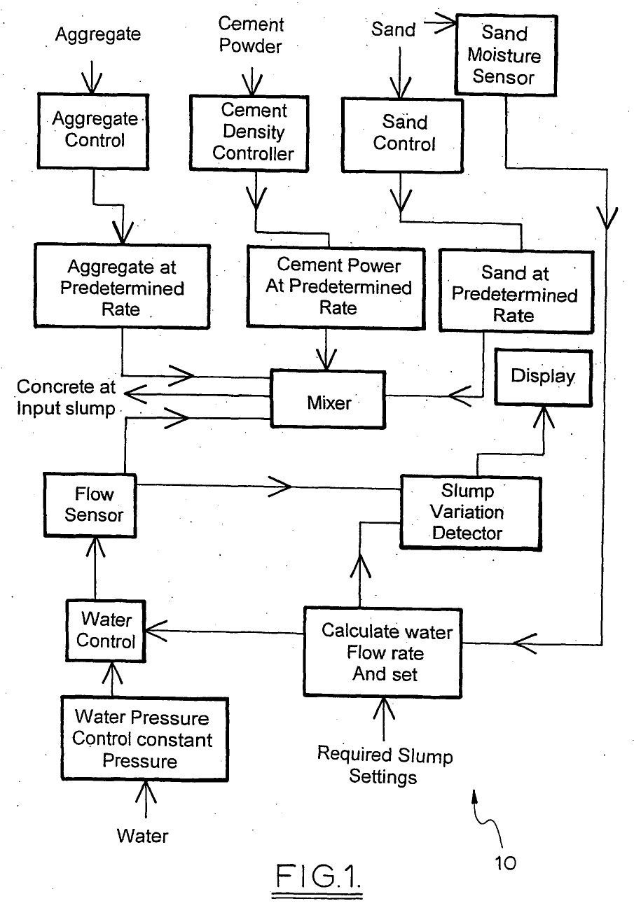

Referring to FIG. 1 there is illustrated in block diagram form the elements of a concrete delivery system where “Aggregate”, “Cement Powder”, “Sand” and “Water” are separately stored on a vehicle and fed at predetermined rates into a “Mixer” for continuous delivery of the mix at a set predetermined slump. Variation from the set slump is indicated on a “Display”. In the illustrated embodiment the “Slump Variation Detector” compares measured water flow rate from the “Flow Sensor” with the “Calculated Water Flow Rate” determined by the “Required Slump Settings” as the water control is set to match. Thus a purchaser of concrete has a visual indication of slump at the display provided on a continuous basis as the concrete is being dispensed and within industry standard limits. The ratio of aggregate, cement powder and sand remains constant due to the cement powder being fully areated and a common mechanical drive. The “Sand Moisture Sensor” is used to account for water already in the “Sand”.

The invention is preferably implemented in vehicles having gravity feed of dry ingredients to various arrangements of augers arranged so that a constant flow rate may be achieved. Storage bins suitably shaped in non-tipping vehicles may be used as may tipping vehicles be used to feed augers. Typical vehicles will now be described.

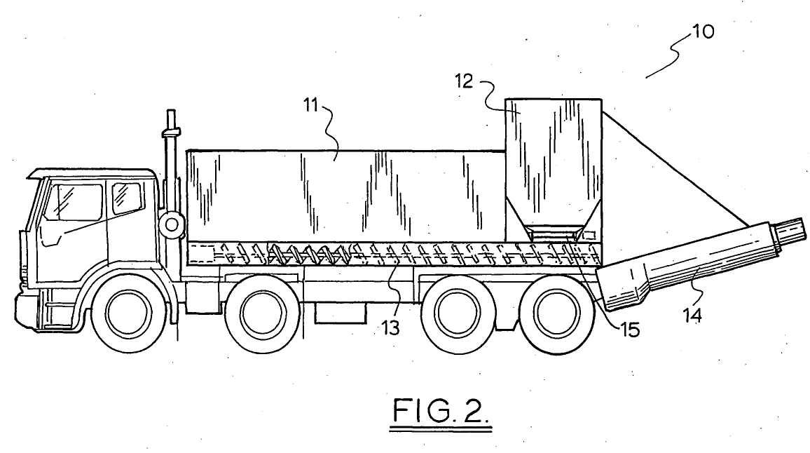

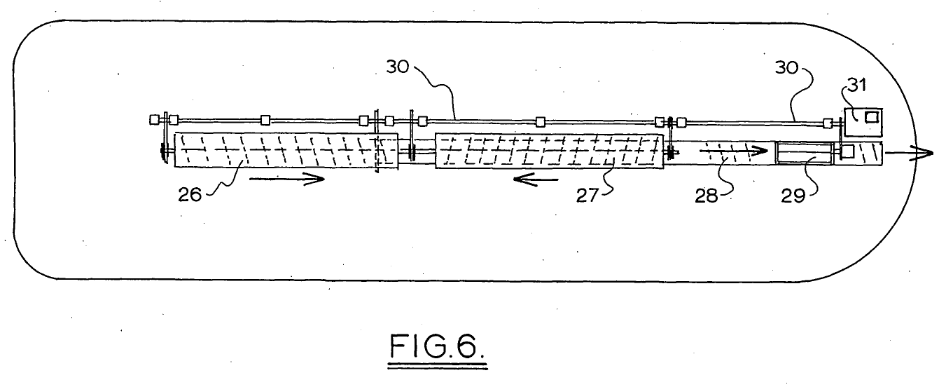

Referring to FIG. 2 there is illustrated a vehicle 10 having a compartment 11 holding blended aggregate and sand and a compartment 12 holding cement powder. An auger 13 carries the aggregate and sand to a mixer 14 coupled to the rear of the vehicle 10. As the aggregate and sand passes below the compartment 12 cement powder is dispensed by a paddle wheel dispenser 15 where the last stages of the auger 13 pre-coats the aggregate and sand with cement powder before delivering it into the mixer 14 where water is added. The paddle wheel 15 and the auger 13 are controlled to ensure the ratio between cement powder and the aggregate sand mix remains constant. This may be achieved electronically or mechanically. Mechanically, this may be achieved by having a common drive and appropriate gearing to achieve the desired ratio (see for example FIG. 6).

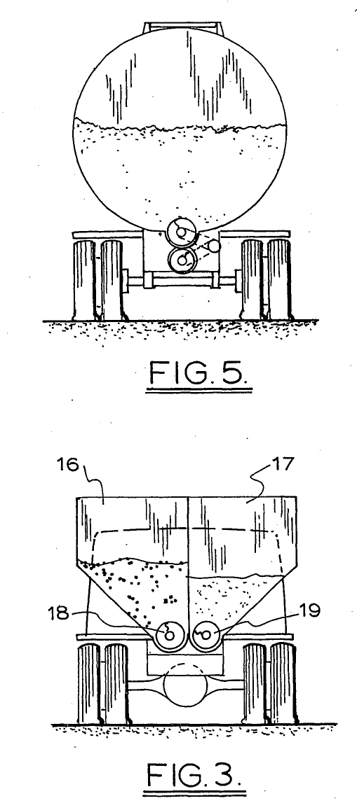

FIG. 3 illustrates an alternative whereby the tank 11 is divided into two tank sections 16 and 17, the tank sections 16 and 17 extending longitudinally and having their own augers 18 and 19. The cement powder may be delivered using two paddle wheels. Aggregate is held in tank section 16 while sand is held in tank section 17.

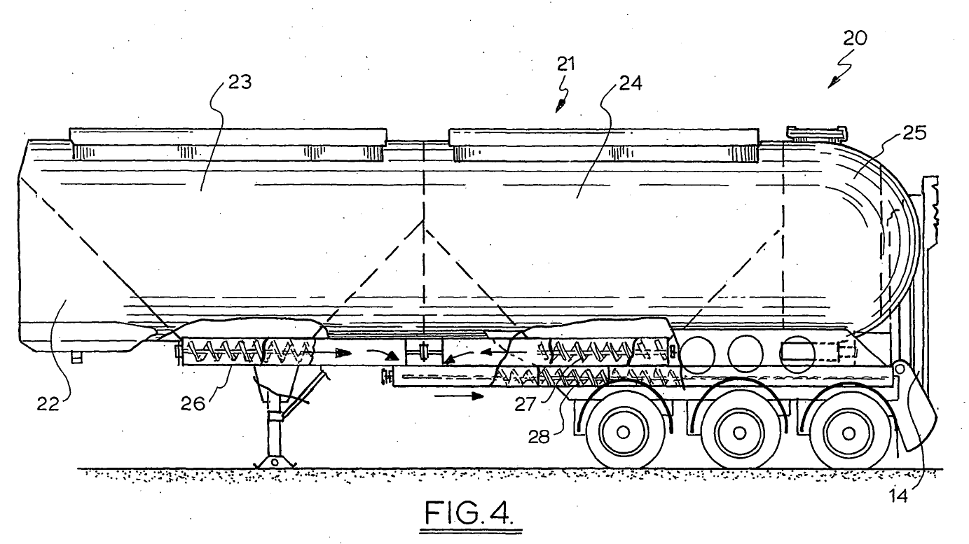

FIGS. 4, 5 and 6 illustrate another embodiment where the vehicle comprises a trailer 20 carrying a tubular container 21 divided into four compartments 22, 23, 24, and 25, the dividers defining the compartments being shown in broken outline. The compartment 22 holds water, the compartment 23 holds aggregate, the compartment 24 holds sand and the compartment 25 holds cement powder. In this case the cement powder in compartment 25 is held under constant pressure aeration to prevent it compacting. Three augers are employed, an auger 26, an auger 27 and an outlet auger 28, the augers 26 and 27 being driven by a common drive shaft 30 which also is common to the paddle wheel 29 delivering cement powder to the outlet auger 28. The outlet auger 28 is also driven via the same drive shaft 30 from drive 31. The augers and paddle wheel are coupled to the drive shaft 30 using suitable sprockets and chain settings to determine the ratio of dry ingredients. It will be realised that this common drive keeps the ratio constant since any resistence that might slow one auger will slow the whole drive assembly the same amount. Water is pumped from tank 22 through a metre related to the rotation of the paddle wheel 29. A mixer 14 is also employed at the rear of the tank. The section through the tank is illustrated in FIG. 5. Sliding doors are employed between the augers 26 and 27 and their respective compartments so that the augers may be kept clear of compacted aggregate or sand that may arise in transit. The doors are not illustrated in FIG. 4.

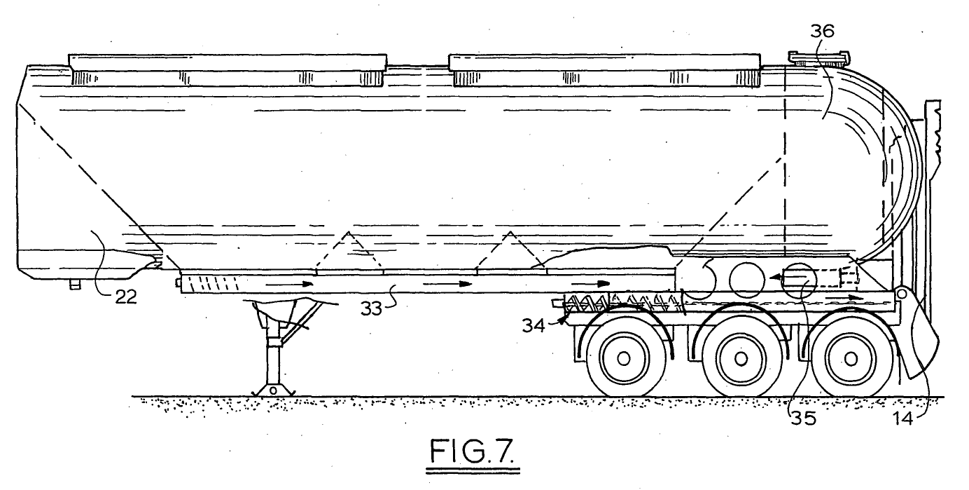

FIG. 7 shows a slightly different arrangement of augers since in this case there is a single compartment 32 holding blended aggregate and sand which flows onto the auger 33 and then in turn onto an outlet auger 34 where cement powder is added via the auger 35 from a cement powder tank 36 ultimately being combined in the mixer 14. The augers may be driven by a common drive arrangement and similar configurations to the embodiment of FIG. 6.

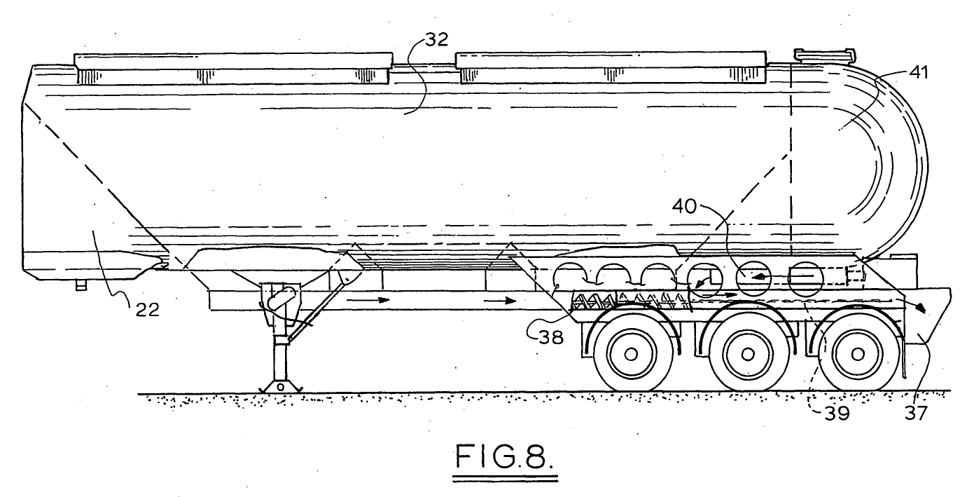

FIG. 8 illustrates an embodiment particularly suited to pumped concrete where concrete can be pumped directly from a rear hopper 37 by reason of the auger 38 having a mixer 39, water is introduced from the tank 22 after cement powder is introduced via an auger 40 from cement tank 41. Thus the mix delivered into hopper 37 is fully blended ready to be pumped. It will be appreciated that a cement pump may be mounted directly in the position of hopper 37 and transported with the vehicle.

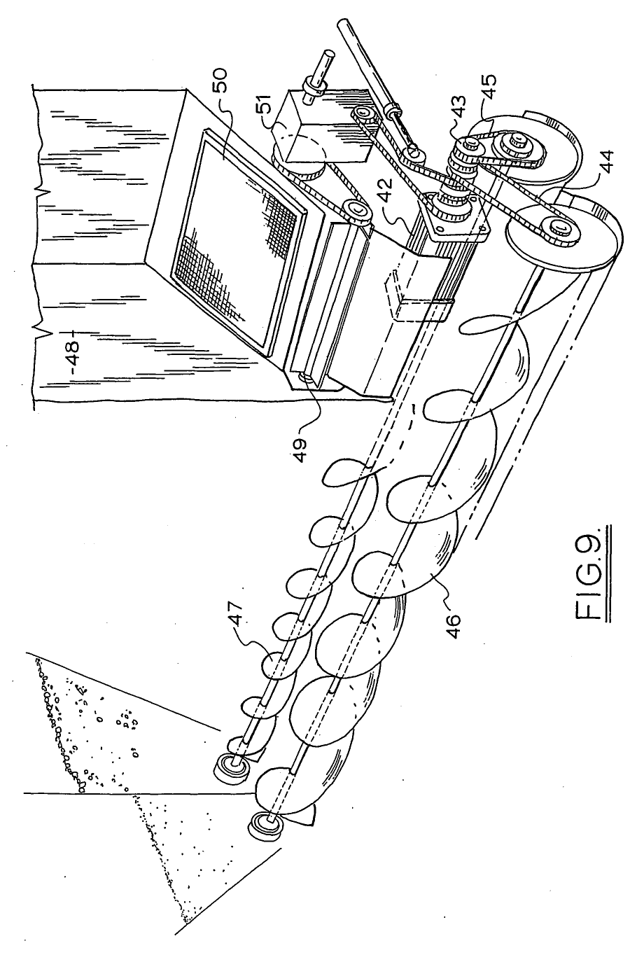

Referring to FIG. 9 a typical arrangement of metering means is illustrated for sand, aggregate and cement powder. A hydraulic motor 42 is of the positive drive type with minimum slippage drives an output shaft 43. This output shaft 43 has multiple chain gears so that chains 44 and 45 may be moved onto a selected chain gear to change the batch design, in terms of the sand and aggregate metered by augers 46 and 47 respectively which are at the bottom of respective V-bins. A V-shaped cement tank 48 has an auger or paddle wheel dispenser at 49 and a pair of air mats 50 (one is shown) on opposite sides of the dispenser 49. A gear box at 51 allows the cement rate to be controlled so that the strength of the concrete may be varied.

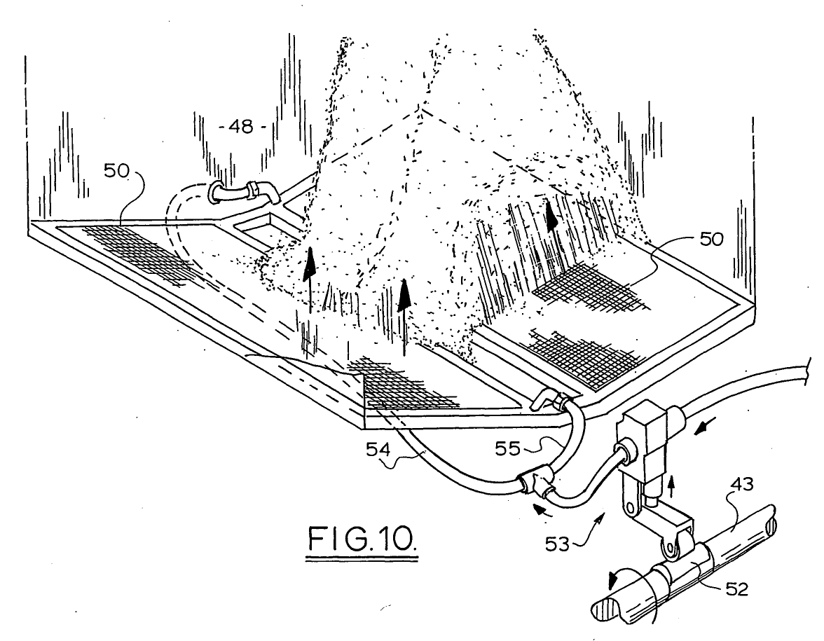

FIG. 10 illustrates the operation of air mats 50. A shaft which may be the shaft 43 has a cam arrangement 52 which drives a pump delivering air along lines 54 and 55 to the mats 50. A bi-pass valve is typically employed so that areation does not take place during mixing.

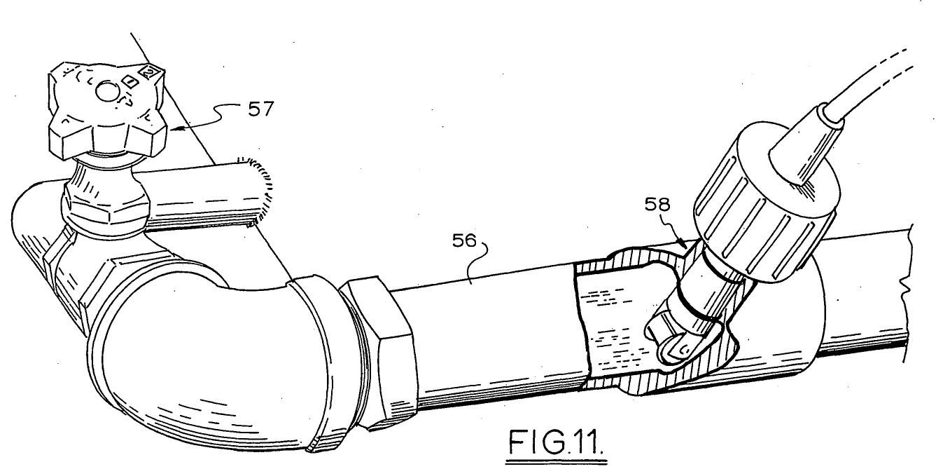

FIG. 11 illustrates a main water line 56 which has a control valve and a flow sensor at 58, as the valve 57 is adjusted the slump indicator will eventually show the correct flow rate for the required slump. This may be set before any concrete is mixed and to the satisfaction of the customer.

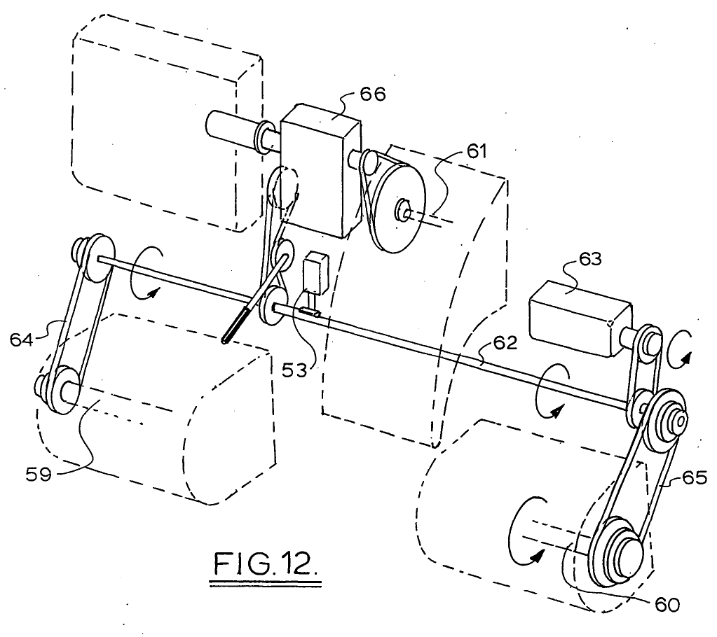

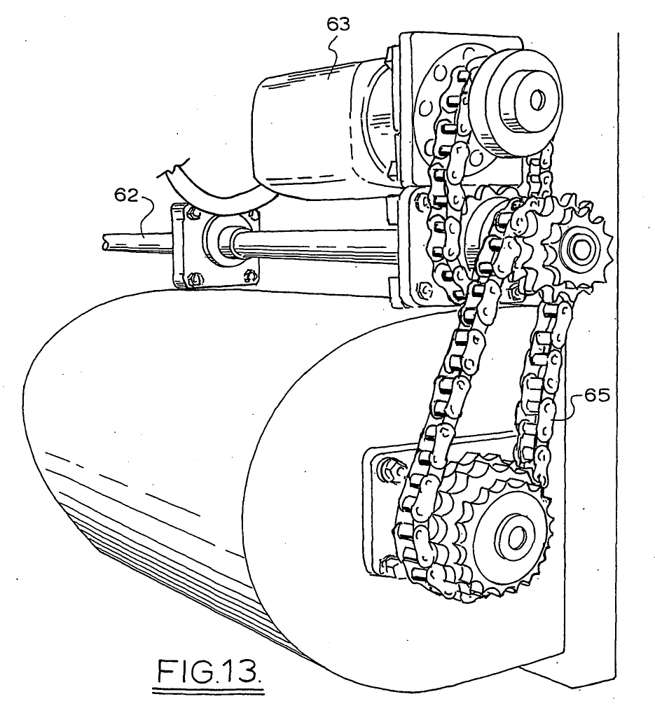

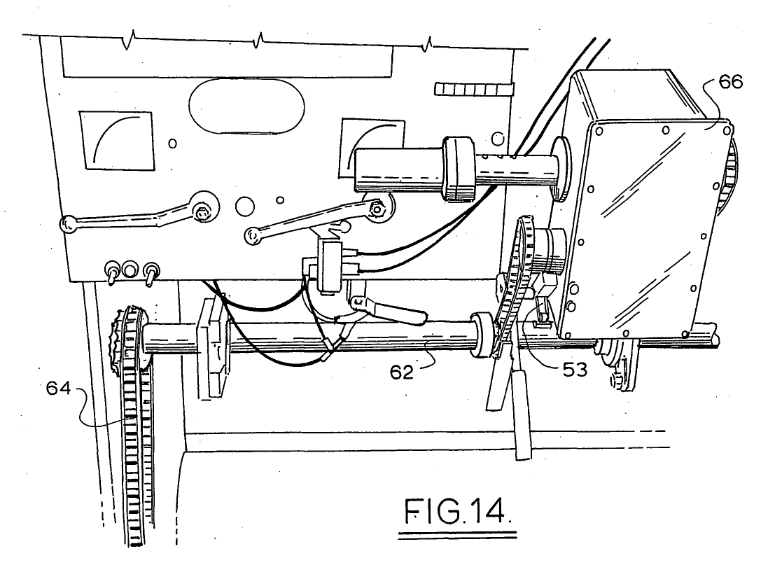

FIG. 12 is a schematic drawing of an arrangement for a divided tipping vehicle where augers 59 and are fed from a tipped trailer with sand and aggregate respectively, cement powder is delivered via a paddle wheel dispenser at 61. A common drive shaft 62 is driven by a hydraulic motor 63, via chain drives as shown. The chains 64 and 65 may be moved between different gear wheels to change the mix. A gear box 66 allows the cement powder rate to be changed. The gear wheels are set to enable selection of the standard batch designs. This is more clearly seen in FIGS. 13 and 14.

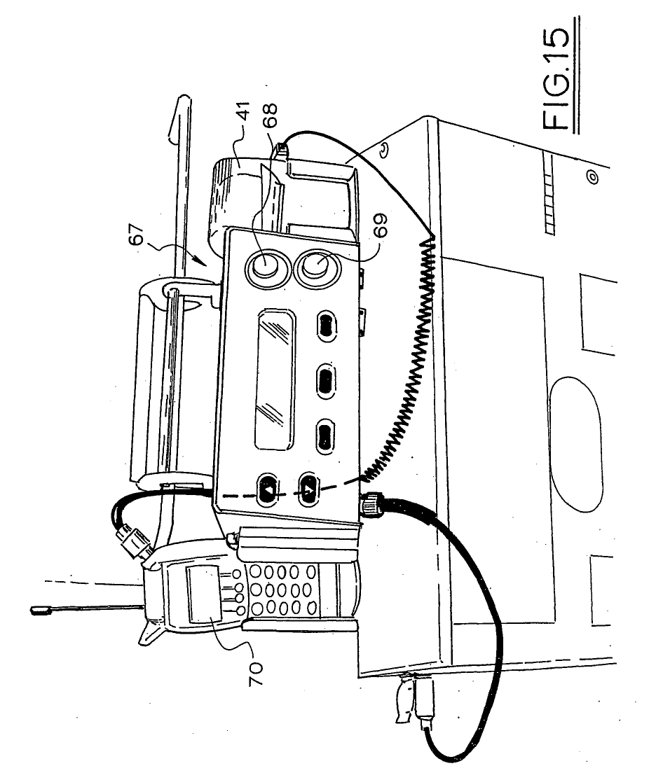

FIG. 15 illustrates a typical display 67 delivering the functions set out in FIG. 1, notably input of required slump settings either directly or as a required flow rate for comparison purposes for slump variation detection. In the illustrated embodiment high and low indicator lamps 68 and 69 are used to show any unacceptable variation from the required slump. The cumulative total of concrete dispensed is displayed so the purchaser has a dynamic indication of slump and the total meterage of concrete. Merchant facilities for dial up banking are also integrated into the system so that the purchaser may prepay for the concrete. A hand held “EFTPOS” unit is shown at 70 along with a printer at 41.

Whilst the above has been given by way of illustrative example of various forms of the present invention many modifications and variations will be apparent to those skilled in the art without departing from abroad ambit and scope of the invention as set out in the appended claims. For example, the augers may be housed in flexible rubber tubes to prevent jamming. The outlet auger in FIG. 4 may be replaced by an endless conveyor belt and so on. The slump monitor may include a continuous print-out of slump with time so that the customer has a full hard copy record of the concrete dispensed at the time. Thus the printer 41 of FIG. 15 may be set to provide this function.

1. A mobile dry to wet concrete system for continuous mixing and delivery of concrete from dry ingredients on-site, the system comprising a vehicle having compartments holding separate the dry ingredients for concrete, a mixer downstream of the compartments for receiving the ingredients and mixing them together, characterised in that, the system has a customer interface including a slump monitor.

2. A system according to claim 1 wherein the slump monitor comprises visual indicator means activated automatically in the event slump of concrete being dispensed falls outside predetermined limits.

3. A system according to claim 1 wherein the slump monitor comprises visual indicator means activated automatically in the event slump of concrete being dispensed falls outside predetermined limits, the visual indicator means comprising a normally off indicator which comes on when the predetermined limits are exceeded.

4. A system according to claim 1 wherein the slump monitor comprises visual indicator means activated automatically in the event slump of concrete being dispensed falls outside predetermined limits, the visual indicator means comprising a normally off indicator which comes on when the predetermined limits are exceeded, the normally off indicator comprises separate high and low indicators, one of which is activated when the slump moves outside a predetermined slump window.

5. A system according to claim 1 wherein the slump monitor monitors the concrete/water ratio of concrete being poured, and indicates when the mix is high (to much water), low (too little water) or correct slump.

6. A system according to claim 1 wherein the slump monitor wherein an operator is able to adjust water flow to a predetermined setting and thereby pour concrete of desired slump where the customer may view the slump monitor.

7. A system according to claim 1 wherein the slump monitor monitors slump using a flow sensor in a water line, a moisture sensor in the sand, a cement density controller, an adjustable water valve and a computer means.

8. A system according to claim 1 wherein the slump monitor includes a continuous print-out of slump with time so that the customer has a full hard copy record of the concrete dispensed at the time.

9. A vehicle having compartments holding separate the dry ingredients for concrete, a mixer downstream of the compartments for receiving the ingredients and mixing them together, characterised in that, the vehicle is of the non-tipping type and the relative quantities of ingredients are controlled to remain constant during a mixing cycle, the dry ingredients delivered to the mixer being controlled continuously by means of metering and conveying means automatically maintaining the relative relationship between the amounts of dry ingredients throughout a mixing cycle for practical consistency of the mix throughout the cycle.

10. The vehicle according to claim 9 wherein the metering and conveying means are linked mechanically by a longitudinally extending common drive shaft.

11. A vehicle according to claim 9 wherein the mixer is fixed relative to the vehicle having a discharge point into an inlet adapted to discharge into a concrete pump.

12. A vehicle according to claim 9 wherein the mixer is a fixed mixer located at least in part within the periphery of the vehicle.

13. A vehicle according to claim 9 wherein the vehicle has at least three compartments holding dry ingredients, one compartment holding aggregate, one compartment holding fines and one compartment holding cement powder, each compartment having a conveyor, the conveyors of the aggregate and fines being dispersed to combine the aggregates and fines together prior to the cement powder being added.

14. A vehicle according to claim 10 wherein the mixer is fixed relative to the vehicle having a discharge point into an inlet adapted to discharge into a concrete pump.

15. A vehicle according to claim 10 wherein the vehicle has at least three compartments holding dry ingredients, one compartment holding aggregate, one compartment holding fines and one compartment holding cement powder, each compartment having a conveyor, the conveyors of the aggregate and fines being dispersed to combine the aggregates and fines together prior to the cement powder being added.

16. A vehicle according to claim 11 wherein the vehicle has at least three compartments holding dry ingredients, one compartment holding aggregate, one compartment holding fines and one compartment holding cement powder, each compartment having a conveyor, the conveyors of the aggregate and fines being dispersed to combine the aggregates and fines together prior to the cement powder being added.

17. A vehicle according to claim 12 wherein the vehicle has at least three compartments holding dry ingredients, one compartment holding aggregate, one compartment holding fines and one compartment holding cement powder, each compartment having a conveyor, the conveyors of the aggregate and fines being dispersed to combine the aggregates and fines together prior to the cement powder being added.
